(19) United States
(12) Patent Application Publication
(10) Pub. No.: US 2007/0154232 A1
(43) Pub. Date: Jul. 5, 2007

(54) Contacting removable printer cartridges

(75) Inventors: John Andrew Buchanan, Paris, KY (US); Benjamin Keith Newman, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/325,399

(22) Filed: Jan. 4, 2006

(51) Int. Cl. G03G 15/00

(52) U.S. Cl. 399/90

(57) ABSTRACT

Resilient wire contacts may be utilized to make electrical contact from printer housings to replaceable printer cartridges such as toner cartridges. As a result, power may be supplied from the printer housing to the printer cartridge in a way that the printer cartridge may be removed and replaced and the electrical contact reestablished. In this embodiment, the wire contacts directly touch conductive bearings which support printing rollers. In this embodiment, the entire wire contact may be established by a single piece of wire shaped appropriately.

### BACKGROUND

This invention relates generally to removable printer cartridges for printers.

Printers may include one or more removable cartridges. The cartridges may include replaceable components that tend to be used up or wear out in the course of printer operation. Thus, when one or more parts are consumed, they may be replaced with a plug-in replacement cartridge. For example, in some printers, replacement cartridges are provided for each of four toner color systems used in the printer. When one of the four cartridges wears out, a replacement cartridge may be supplied.

Generally the replacement cartridge plugs into the spot left vacant by the consumed and removed cartridge. In many cases, the cartridges must receive electrical power. They need electrical power to rotate rotatable elements, bias components, and in some cases to power various sensors, detectors, and other components.

Generally power is supplied in a way that, when the cartridge is plugged into the printer, power is automatically coupled from the printer to the cartridge. This coupling may be accomplished using sheet metal contacts arranged to be contacted when the cartridge is properly installed.

However, such sheet metal contacts may have some disadvantages. It is desired to have improved techniques for contacting removable or replaceable printer cartridges.

### BRIEF DESCRIPTION OF THE DRAWINGS

FIG. 1 is a partial, perspective view of one embodiment of the present invention;

FIG. 2 is a partial, top plan view of the embodiment shown in FIG. 1; and

FIG. 3 is a partial, front elevational view of a cartridge shown in FIGS. 1 and 2.

### DETAILED DESCRIPTION

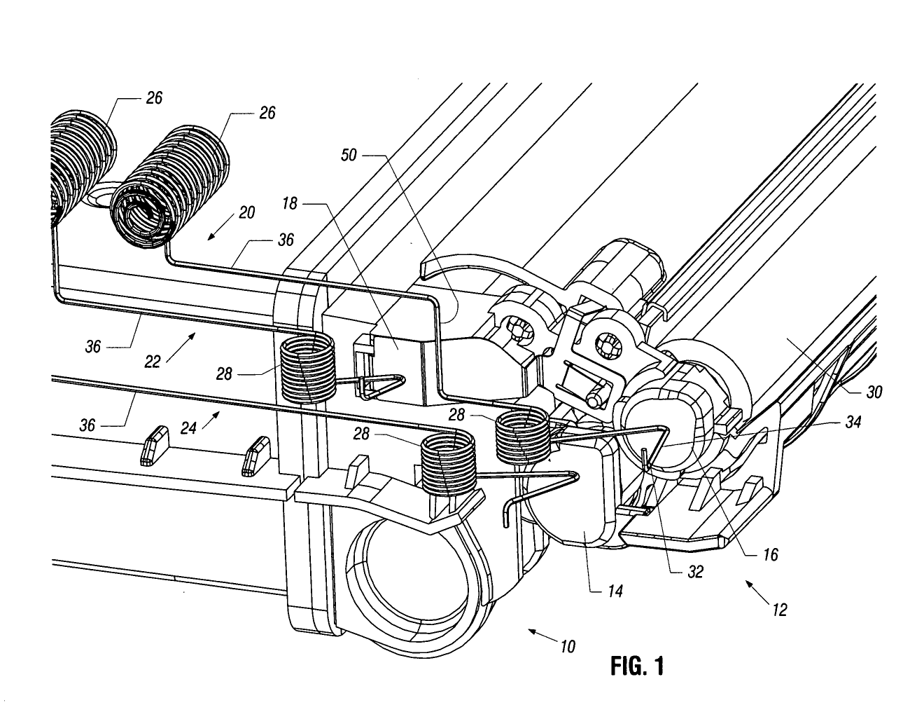

Referring to FIG. 1, a printer 10 may include at least one removable cartridge 12. The cartridge 12 may include elements 30, all of which may be replaced as a unit in one embodiment. Each of the elements 30 are formed in one embodiment with an end piece 14, 16, or 18 which may include a sintered bronze or conductive plastic bearing.

Wire metal conductors 20, 22, and 24 are wire strips that may be formed of a resilient, conductive metal wire. The metal wire conductors 20, 22, and 24 start with a bent free end 32 coupled to a generally V-shaped electrical contact 34. The contact 34 is pressed against an end piece 14, 16, or 18, for example by a coil spring 28. The coil springs 28 may be mounted on the printer 10 and not the cartridge 12. The springs 28 may be mounted on an arbor (not shown) which is part of the printer housing.

When the cartridge 12 is removed, the contact 34 springs inwardly, under bias by the spring 28, into the vacant area left open by the removed cartridge 12. When the cartridge 12 is replaced, the resilient contact 34 is displaced outwardly to make electrical contact with an end piece 14, 16, or 18, biased by the spring 28.

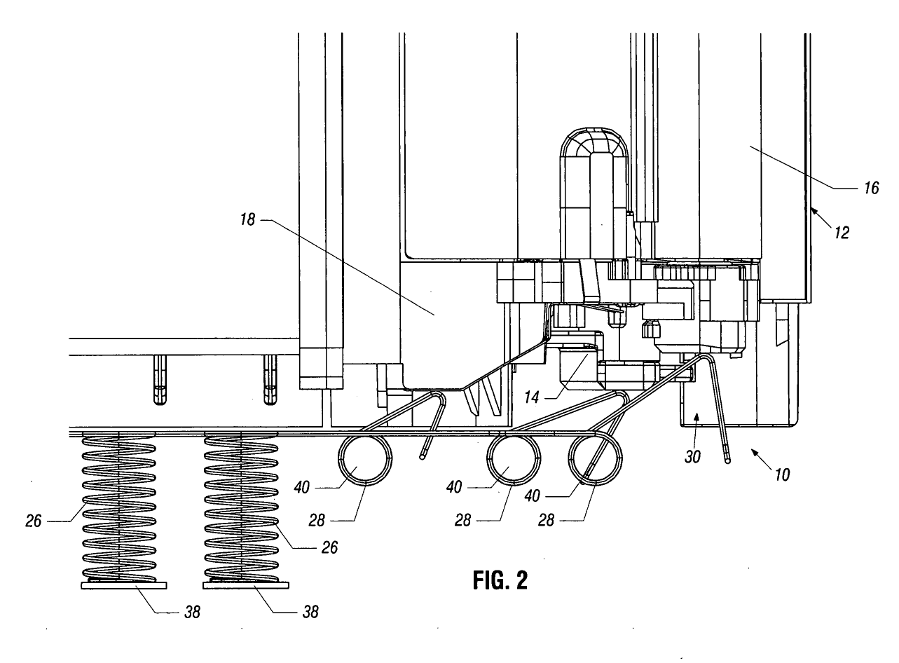

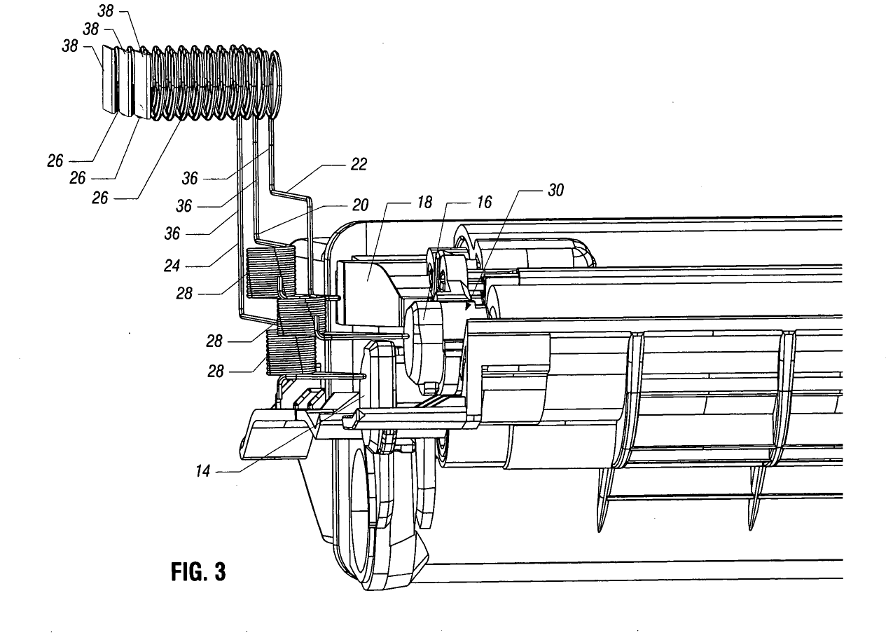

The coil springs 28 are connected by wires 36 to compression springs 26. The compression springs 38 on their free ends in turn make contact with power contact 38. The power contacts 38 are better shown, for example, in FIGS. 2 and 3 and connect to a source of power within the printer 10.

A toner adder roll includes the conductive end piece 14 coupled to a power supply potential by the wire conductor 24. The conductive end piece 14 is contacted by a similar V-shaped contact 34 connected to a coil spring 28 connected by a wire 36 to a compression spring 26. The spring 26 contacts a power contact 38 supplying a high negative voltage, for example.

The conductor 20 supplies a power supply potential to the end piece 16. The end piece 16 supports the developer roll 30. The end piece 16 may be a conductive bearing, which is coupled to the developer roll shaft (not shown) in one embodiment. A contact 34 is coupled to coil spring 28, coupled by a wire 36 to a compression spring 26. That compression spring 26 is coupled to power contact 38 that supplies a large negative voltage that may be larger than the negative voltage applied to the toner adder roll. The conductor 20 wire 36 may include a downset 50 to enable the conductor 20 to contact the end piece 16.

The conductor 22 couples a doctor blade unit to a power contact 38, through a wire piece 36, a coil spring 28 and a compression spring 26. In one embodiment, the doctor blade unit receives the highest negative voltage applied through the end piece 18.

In some embodiments of the present invention, each conductor 20, 22, or 24 may be formed of a single integrated metal wire bent into shape using an appropriate jig. As a result, a wire contact system may be less expensive than conventional sheet metal contacts in some embodiments.

Moreover, when the cartridge 12 is removed, the spring contacts spring into position, interfering with the subsequent insertion of the replacement cartridge. However, whenever the replacement cartridge 12 is forced into place, the spring contacts 34 spring out the interfering position to a position in complete electrical contact with the end pieces 14, 16, 18. This contact is an effective electrical connection because of the force applied by the coil springs 28 to the contacts 34.

Similarly, the electrical connection on the other end of the conductors 20, 22, 24 to the power supply is effective because the exact same metal wire may be used in some embodiments to form the compression spring 26 that contacts the power contact 38. Thus in some embodiments, a single wire may supply the entire connector from the power contact 38 to an end piece 18, 14, or 16.

Electrical contact is made through the end pieces 14, 16, 18 to any metal shaft of associated rollers or elements.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming an electrical power contact for a printer cartridge using resilient wire on said printer resiliently biased against said cartridge; and
using wire to make electrical power contact to an end piece of a printer roller support bearing.

2. The method of claim 1 including coupling a printer cartridge element to an electrical power contact using a single piece of resilient wire.

3. The method of claim 2 including forming a torsion coil spring and a compression spring in said piece.

4. The method of claim 3 including forming an electrical contact in said piece to contact said cartridge using a bent end of said piece.

5. The method of claim 1 including forming a resilient cantilevered contact on a free end of said piece.

6. The method of claim 1 including contacting a developer roll.

7. The method of claim 1 including contacting a toner adder roll.

8. The method of claim 1 including contacting a doctor blade unit.

9. The method of claim 1 including providing a resilient wire contact with a free end resiliently biased against said printer cartridge.

10. A printer comprising:
a printer cartridge removably located within said printer, said cartridge including a printer roller support bearing end piece; and
a resilient wire contact resiliently biased against said end piece.

11. The printer of claim 10 wherein said resilient wire includes an integrally formed torsion coil spring.

12. The printer of claim 11 wherein said resilient wire includes a compression spring to contact a power source.

13. A method comprising:
forming a contact for a printer cartridge using a single piece of resilient wire on said printer resiliently biased against said cartridge;
coupling a printer cartridge element to a power contact using said resilient wire; and
forming a torsion coil spring and a compression spring in said wire.

14. The method of claim 13 including forming a contact in said piece to contact said cartridge using a bent end of said piece.

15. The method of claim 13 including forming a resilient cantilevered contact on a free end of said piece.

16. The method of claim 13 including using wire to make contact to an end piece of a printer roller.

17. The method of claim 13 including contacting a developer roll.

18. The method of claim 13 including contacting a toner adder roll.

19. The method of claim 13 including contacting a doctor blade unit.

20. The method of claim 13 including providing a resilient wire contact with a free end resiliently biased against said printer cartridge.

21. A printer comprising:
a printer cartridge removably located within said printer;
a resilient wire contact resiliently biased against said cartridge, said resilient wire including an integrally formed coil spring; and
a compression spring to contact a power source.

22. The printer of claim 21 wherein said resilient wire is an integral wire piece to couple a power source to said cartridge.

23. The printer of claim 21 wherein said torsion coil and compression springs are formed in a single integrated wire.

24. The printer of claim 21 wherein said resilient wire includes a free end having a bent portion, biased by a torsion coil spring against said cartridge.

25. The printer of claim 21 including three resilient wires, each contacting a different element in said printer cartridge.

26. The printer of claim 25 including a wire to contact a developer roll.

27. The printer of claim 25 including a resilient wire to contact a toner adder roll.

28. The printer of claim 25 including a resilient wire to contact a doctor blade unit.
